(19) United States
(12) Patent Application Publication
(10) Pub. No.: US 2005/0071986 A1
(43) Pub. Date: Apr. 7, 2005

(54) Apparatus and method for closed loop feedback during lapping of magnetic heads

(75) Inventors: Lauren Lackey, Simi Valley, CA (US); Stanley Lackey, Camarillo, CA (US)

Correspondence Address: KOPPEL, JACOBS, PATRICK & HEYBL, 555 ST. CHARLES DRIVE, SUITE 107, THOUSAND OAKS, CA, 91360, US

(73) Assignee: VEECO AII

(21) Appl. No.: 10/846,394

(22) Filed: May 13, 2004

Related U.S. Application Data
(60) Provisional application No. 60/470,782, filed on May 13, 2003.

(51) Int. Cl. H04R 31/00

(52) U.S. Cl. 29/603.16

(57) ABSTRACT

A disk drive element lapping system with closed loop feedback comprising a row of a plurality of disk drive elements and a lapping plate for lapping the plurality of disk drive elements. A plurality of current sources is included, each of which applies a current to a respective one of the plurality of disk drive elements. A coil for applying an alternating magnetic field to the plurality of disk drive elements. A plurality of monitors is included, each of which monitors the voltage across a respective one of the plurality of disk drive elements in response to the direct current and the alternating magnetic field. A processor determines the magnetic responsiveness of each of the plurality of disk drive elements based on the monitored voltage.

This application claims the benefit of provisional application Ser. No. 60/470,782 to Lackey et al., which was filed on May 23, 2003.

### BACKGROUND OF THE INVENTION

1. Field of the Invention

This invention relates to lapping systems for hard drive magnetic heads.

2. Description of the Related Art

Magnetic heads (also called sliders or elements) for hard drives read data from the media (also called platter or disk) by sensing changes in magnetic field strength emanating from magnetic grains in the media. Magnetic heads can also function as a writer and can generate a magnetic field that orients the grains based on whether a one or zero is stored. The data is stored magnetically by alternating magnetic fields created by the writer as the gap (space between the poles) of the electromagnetic element glides or slides over the surface of the disk. The data is stored on the disk in a circular pattern with data tracks spaced as close as ten millionths of an inch apart, with as many as one hundred thousand tracks per inch. The data is stored by the writer in a track as individual “bits” at as many as five hundred thousand bits per inch, or as close together as two millionths of an inch. The data can then be read back by the reader part of the head which contains a “magneto-resistive” material between two shields, with the magneto-resistive material changing resistance based on the magnetic orientation of a magnetic field.

The fabrication of magnetic heads can be a complex process. The reader and writer elements are typically deposited on a ceramic wafer that is then sliced into individual rows or a block of several rows. These individual rows or block of rows are then bonded onto a row tool for the lapping operation. Depending on the size of the heads and the length of the rows, there may be from 30 to 80 heads that are lapped simultaneously and therefore, using conventional lapping processes, all heads should meet the end target at the same time. This lapping (or polishing) procedure removes material from the lower surface of the row and is one of the final procedures in manufacturing the magnetic heads/sliders to write data to the surface of the disk in a hard drive and then to read that same data.

Conventional row tools can have control points that are designed to influence the row on the row tool to allow the lapping process to define the primary shape of the row of sliders, the primary surface finish, critical device dimensions (distance from reading and writing elements to machined surface), and the shape and condition of exposed surfaces.

FIGS. 1a and 1b show a typical magnetic element comprising a square area of magneto-resistive material with contacts on the ends which are brought out to wires that are ultimately connected to a signal processor system. The element can be approximately eight microinches high and eight microinches wide, and high-conductivity contacts are connected to the full height of the mango-resistive material, at each end. The element can be analyzed as an array of horizontally-arranged parallel resistors spanning from one contact at the end of the element to the contact on the other end. Each of these theoretical resistors has the magneto-resistive characteristic. If a magnetic field were applied to the entire area of this array, the resistance as measured from the contacts would appear to change, with the direction of the change depending on the polarity of the magnetic field.

As the “reader element” is held in the correct position over the magnetic track, the “magneto-resistive” element reads the magnetic data as reversals of the field. Since the data bits are as close as two micro-inches apart, the reader element could be reading a transition of other bits in front of or behind the reader element as it passes quite rapidly along the data track. To prevent this error, there is a shield on each side of the reader element.

FIG. 2 shows the element of FIGS. 1a and 1b, including a magnetic shield on both sides, with the bottom of the shields at the same level as the bottom of the element. The shield extends considerably past the ends and the top of the element. The only place a magnetic field can reach the magneto-resistive element is at the bottom. The shield is placed very close to the element (within a half microinch) and the element is made very thin to reject the signal fields of the near-by bits on the disk. This establishes the requirement to build the shield-element-shield configuration within about a micro-inch to read the desired bit and ignore the data bits only two microinches in front of it or in back of it.

The shields are very close to the element and to each other such that the data bit being read can also be attenuated by the shields. So that the magnetic field being read can reach the element, the element must be designed to be very narrow as it stretches across the width of the magnetic track. If the element is higher in the direction perpendicular to the surface of the magnetic disk the signal is attenuated. When a magnetic field of the same strength as before is placed at the bottom of the shield-element assembly, only the theoretical resistors at the bottom of the array are affected by the magnetic field. The lines of force from the magnetic field will not reach inside the shield except for a fringing effect on the element (resistors) at the bottom of the shields.

If the element were considered an array of resistors connected in parallel then only a very few of them at the very bottom of the array change in value, while the rest are not changing. If the total array of resistors (for example) were considered to be one hundred resistors with each resistor equal to one thousand ohms, the resistance of the array would be ten ohms. The magnetic field can change the apparent resistance of a resistor from one thousand ohms by twenty ohms. If five resistors were changed because they were very close to the bottom edge these resistors would show a two percent change in value. However, they are still connected in parallel with ninety-five that did not change in value, such that the measurable effect at the terminals would only be approximately two percent divided by twenty, or only about a one-tenth percent change. This which would be a relatively undetectable or unreadable signal.

By “removing” all the “resistors” except those right at the bottom edge of the shields, the reader element has the maximum sensitivity to the resistance change resulting from the applied magnetic field and to the changes in that field, where the stored data resides. This applied magnetic field could be generated by a field at the bottom of the shield-reader assembly or could be applied in the local area as the shields are effective in making the element insensitive to any magnetic fields except at the edge of the element and reaching only the theoretical resistors at the edge of the shields.

When the sliders are being lapped in the usual process, the bottom edge of the element and the shields are both being removed in a very controlled fashion and the resistance of the element is continually monitored. As the elements are lapped, the element geometry is changed and the remaining cross-sectional area is decreased, resulting in higher and higher resistances. Typically the lapping process is continued and the progressive removal of these “parallel resistors” causes the apparent resistance of the element to increase. In conventional lapping processes the DC resistance of each of the sliders is measured during lapping and lapping stops when a predetermined DC resistance is measured. The goal is to end up with sliders that are most responsive to changes in a magnetic field, without lapping so thin that the heads are destroyed. The optimum performance of a slider in reading data from a disk is achieved when the lapping procedure is terminated at the point of maximum magnetic sensitivity, which may not occur when the D-C resistance of the slider is at the predetermined resistance. Statistical data from testing many read heads has shown the read-capability may be best at element resistances as much as fifty percent above or below the predetermined resistance.

### SUMMARY OF THE INVENTION

One method for monitoring the lapping of disk drive elements according to the present invention comprises applying a DC current to a disk drive element having magneto-resistive properties and applying an alternating magnetic field to the disk drive element. The disk drive element is lapped and the voltage across said disk drive element in response to the DC current and alternating magnetic field is measured. The magnetic responsiveness of the element is determined based on the measured voltage.

One embodiment of a lapping system according to the present invention with closed loop feedback comprises a row tool for holding a row of a plurality of disk drive elements. A lapping plate is included for lapping a plurality of disk drive elements. A current source applies a direct current to at least one of the disk drive elements. A coil applies an alternating magnetic field to at least one of the disk drive elements and a monitor monitors the voltage across the at least one of the disk drive elements in response to the direct current and the alternating magnetic field. A processor determines the magnetic responsiveness of at least one of the disk drive elements based on the monitored voltage.

One embodiment of a disk drive element lapping system with closed loop feedback comprises a row of a plurality of disk drive elements and a lapping plate for lapping the plurality of disk drive elements. A plurality of current sources is included, each of which applies a current to a respective one of the plurality of disk drive elements. A coil applies an alternating magnetic field to the plurality of disk drive elements. A plurality of monitors is included, each of which monitors the voltage across a respective one of the plurality of disk drive elements in response to the direct current and the alternating magnetic field. A processor determines the magnetic responsiveness of each of the plurality of disk drive elements based on the monitored voltage.

These and other further features and advantages of the invention would be apparent to those skilled in the art from the following detailed description, together with the accompanying drawings, in which:

### BRIEF DESCRIPTION OF THE DRAWINGS

FIG. 1a is a perspective view of a prior art magneto-resistive device;

FIG. 1b is a bottom view of the magneto-resistive device of FIG. 1a;

FIG. 2 is a bottom view of the magneto-resistive device in FIGS. 1a and 1b, with magnetic shields;

FIG. 3 is a block diagram of one embodiment of a lapping system according to the present invention;

FIG. 4 is a block diagram of another embodiment of a lapping system according to the present invention;

FIG. 5 is a front view of one embodiment of lapping system according to the present invention;

FIG. 6 is a side view of the lapping system shown in FIG. 5;

FIG. 7 is a sectional view of the lapping system shown in FIG. 5;

FIG. 8 is a bottom perspective view of the lapping system shown in FIG. 5;

FIG. 9 is a perspective view of one embodiment of an apparatus according to the present invention to generate a rotating magnetic field;

FIG. 10 is a sectional view of the apparatus in FIG. 9; and

FIG. 11 is a block diagram of one embodiment of a magnetic pulse generating system according to the present invention.

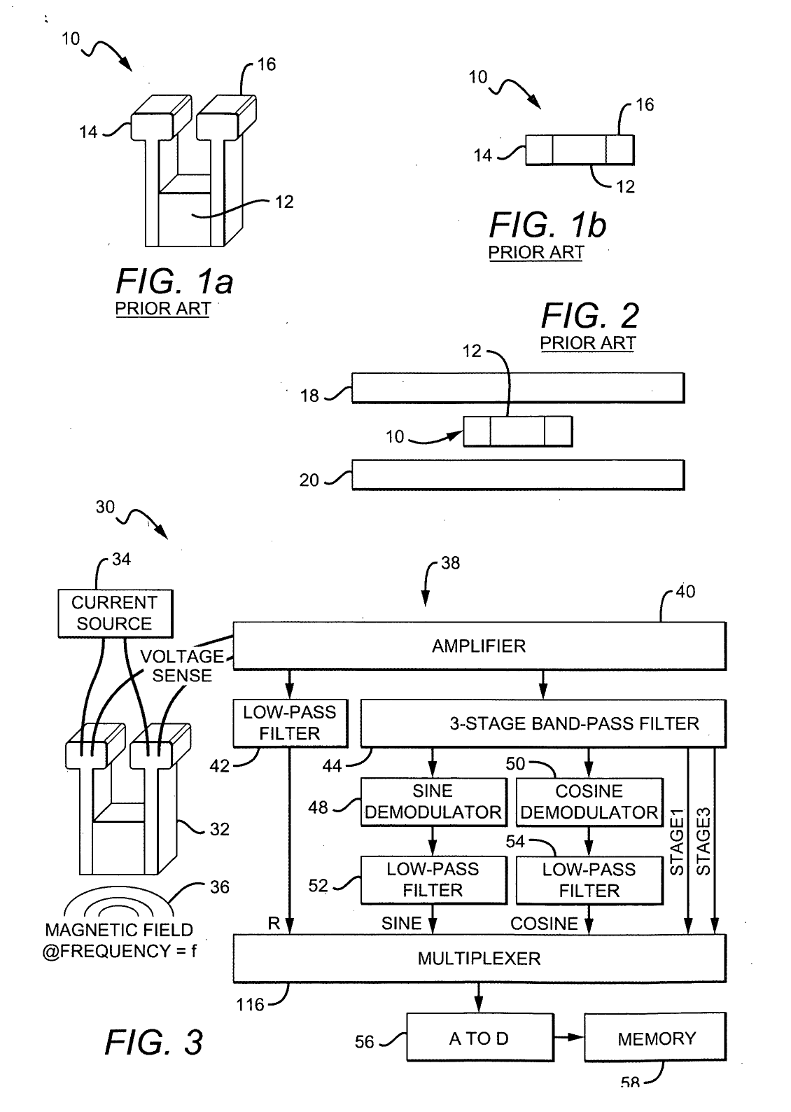

### DETAILED DESCRIPTION OF THE INVENTION

The present invention is directed to an apparatus and method for lapping magnetic heads in an alternating magnetic field and continuously monitoring the magnetic performance of the heads (sliders or elements) being lapped by measuring the change in magneto-resistance synchronous to the oscillating magnetic field as the final feedback to determine the optimum lapping stop point. The measured (and then processed) parameter is the amplitude of dynamic resistance change synchronous to the alternating magnetic field to the resistance of the element. The DC resistance-to-magnetic-performance correlation problem is greatly reduced by using magneto-resistive feedback during lapping, such that magnetic head manufacturers utilizing the invention can have a much better control of the lapping process to provide better yields and achieve higher area densities.

With this approach the absolute accuracy of the resistance measurement is less critical as compared to using element resistance as the only lapping criteria. It is the relative values of magneto-resistive component of the signal and the D-C component that determines the optimum stop-point of the mechanical lapping procedure, when the geometry of the element in the slider will provide the best performance in a disk drive.

FIG. 3 shows a block diagram of one embodiment of a lapping system 30 according to the present invention that can be used to optimize the element lapping process. The system 30 is particularly adapted to continually monitoring the magnetic performance during the lapping procedure of a row of elements to optimize the lapping procedure and determine the optimum lapping stop point on an element-by-element basis.

The system 30 is arranged such that a DC current can be coupled to the element 32 and the element 32 can be exposed to an alternating magnetic field, both during the lapping process to monitor the element's sensitivity. In one embodiment according to the present invention, the DC current is supplied by a current source 34 and a constant-amplitude alternating (sine-wave) magnetic field 36 applied to the element using a coil (not shown) that is parallel to and closely surrounding the row of elements sliders. The voltage response is then measured, with the highest sensitivity of the element 32 being when the “delta R over R” ratio is greatest. That term relates to simultaneous measurements of the AC component (“delta R”) of the voltage drop across the element to the DC component (“R”) of the voltage drop, as measured with a prescribed constant DC current from the current source 32 flowing through the element 34 and a prescribed alternating magnetic field.

The magnetic field is applied to the heads for several magnetic cycles before any measurements are taken and maintained long enough to make various measurements on each slider including the sine component, cosine component and recording the actual waveform at several points in the amplifier path. This measurement is done for each head and for several calibration resistors during each measurement interval and then the magnetic field is turned off until the next measurement cycle is started.

The voltage drop across the element is measured using a “four-wire” measurement technique and the voltage drop is transmitted to a voltage monitoring system. Each element has a separate current source 32 and its own voltage monitoring system 38, although other systems according to the present invention can have one or more current sources that supply current to multiple elements.

The voltage drop signal is coupled to an amplifier 40 with the signal then being coupled to an active low pass filter 42 and a 3 stage band-pass filter 44. The low pass filter is arranged to reject the AC component of the voltage drop signal, leaving the DC component that is coupled to a multiplexer 46. The A-C component of voltage across the element at the frequency of the applied magnetic field is applied to a band-pass filter 44 to reject the D-C component and the A-C components at frequencies far-removed from the frequency of the applied magnetic field. The restricted-bandwidth signals from the band pass filter 44 is applied to sine synchronous demodulator 48 and cosine demodulator 50, both of whose switching frequency is the same as the frequency of the applied magnetic field but whose phases are displaced by a quarter-cycle, or 90 degrees. The average value of the outputs of each of the synchronous demodulators 48, 50 is proportional to the amplitude of the input signal times the sine (or cosine) of the phase angle. Sine and cosine low pass filters 52, 54 are arranged between the sine and cosine demodulators 48, 50 and the multiplexer 46.

The values of the sine and cosine components are extracted after the last stage of the band pass filter. This is also done on all channels simultaneously. The multiplexer 46 can be dedicated to voltage monitoring system 38 or can be arranged to accept inputs from many voltage monitoring systems. The DC component from the low pass filter 42 and the sine and cosine components pass through the multiplexer and through an analog to digital converter 56 that generates a digital form of the analog signals. The signals are then sent to memory 58 or a computer for processing. The magnitude of the “delta R” is equal to the square root of the sum of the sine component squared and the cosine component squared. Either or both of the sine and cosine components may be negative but the squares are positive. The true value of the phase of the “delta R” may be computed by the arctangent of the sine component divided by the cosine component.

The actual wave shape at two points in the band-pass amplifier is sampled at more than twenty points in one cycle of the frequency of the applied magnetic field and stored in the computer as well as the other measurement information. The band pass of the signal is more restricted as it passes through successive stages and a distorted wave becomes closer to a sine wave as it passes those additional stages. Signal components of frequencies further removed from the center frequency are more attenuated and therefore distortion components are attenuated. By monitoring after an earlier stage, distortion components are more preserved. By monitoring at two points relative value of each concept can be analyzed.

The computer then determines how each of the elements in the row is responding to the DC current and the alternating magnetic field. The computer can then provide control signals to the row tool to revise the lapping process of the elements in the row. For example, if the computer determines that one of the elements is reaching a point that it is responding favorably to the DC component and magnetic field, while others in the row are not, the computer can control the forces applied to the row tool such that the lapping is applied primarily to the elements that are not yet responding favorably. The lapping of the favorable element is backed off before it is lapped too far. This allows the lapping of the elements in row to be controlled based on the DC and alternating magnetism response of each of the elements.

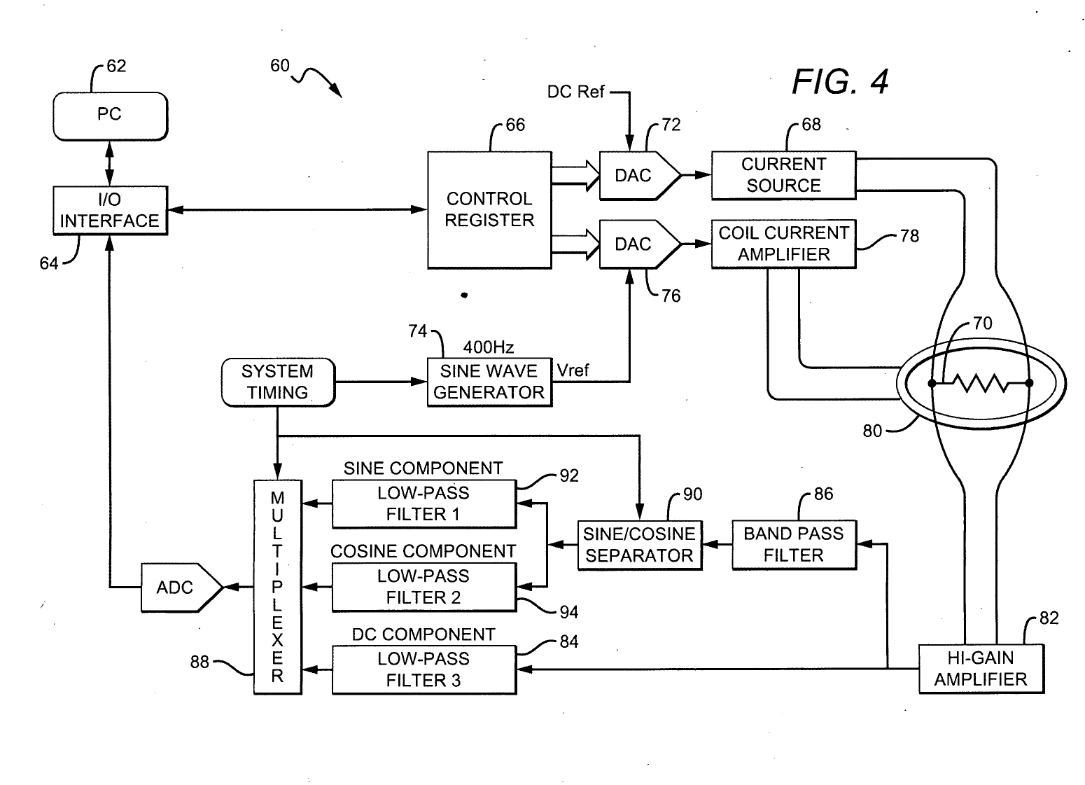

FIG. 4 shows a block diagram of another embodiment of a system 60 according to the present invention that also can be used to optimize the element lapping process. The system 60 is also particularly adapted to continually monitor the magnetic performance during the lapping procedure of a row of sliders to optimize the lapping procedure and determine the optimum lapping stop point on a slider-by-slider basis.

Previous designs have used a common, programmable dual current source (positive and negative and equal in magnitude) and a network of filters and multiplexers to supply excitation current to each slider in a row as its voltage is being measured. This type of supply switching of the test current typically requires resistor-capacitor-diode networks to suppress the current spikes generated by the multiplexers in scanning the sliders in a row. The system 60 is arranged to avoid these current spikes.

The system 60 comprises commercially available components such as a computer 62 that communicates with the system 60 through an I/O Interface 64 and provides binary control commands to the control registers 66. Many different computers can be used, with a suitable computer being a commercially available personal computer. The control registers 66 provide commands related to the magnitude of the current to be provided by the DC current source 68 and the magnitude and/or frequency to be generated by the coil current amplifier 70. In the system 60 each element in the row is provided with its own current source 68 to supply the DC excitation current, with the block diagram showing only one current source 68 driving a single element (or slider) 70. A typical row can have 50-80 sliders, such that the system 10 would have 50-80 current sources. Using this approach the system 10 does not need a current source multiplexer or resistor-capacitor-diode networks to suppress the current spikes generated by the multiplexers. In other embodiments according to the present invention, a single current source 68 can be used to provide a DC excitation current to multiple elements.

A current source digital to analog converter (DAC) 72 provides a programmable reference voltage to the current source 68 and the current source 68 contains precision resistor (not shown) that generates a current to be applied to the element 70. The computer 62 can provide commands to the command register to change the value of the excitation current within a certain range. If it is desired to change the magnitude of the current by a large ratio, the current-setting resistor can be changed to a new value. The current-setting resistors are preferably of a tight tolerance (0.1%) and are assembled in easily-replaceable modules.

A sine wave generator 74 provides an alternating reference voltage (V_{ref}) to the coil current DAC 76, with the control register providing a command to control the magnitude of the alternating current generated at the DAC 76. The output of a the DAC 76 is coupled to a coil current amplifier 78 that in turn couples an amplified alternating current signal to a coil 80. The coil 80 generates a magnetic field in response to the alternating current signal, and the coil 80 can be arranged to apply the magnetic field to one, some or all of the elements in a row. In the preferred embodiment, the coil 80 surrounds the entire row of elements so that all elements experience the same magnetic field.

The voltage across each M-R element is monitored by a separate high gain amplifier 82 using the 4-wire configuration. The 4-wire connection maintains measurement accuracy even with the relatively low-value resistances of the elements at the beginning of lapping when the resistance value is the lowest. As discussed above in regards to the current source 68, there is no need for the filter networks to protect the elements from the noise generated by the switching of the multiplexers as the voltage multiplexers required to scan the values are located electrically after several stages of amplification and active band-pass filtering.

The signal from the amplifier 82 contains a DC voltage component from the resistance of the element in response to the signal from the current source 72 and a superimposed AC voltage component due to the apparent change of resistance caused by the alternating magnetic field from the coil 80 that surrounds the row. The DC component is coupled to a low-pass filter 84 to remove any AC components and is then applied as an input of a scanning multiplexer 88.

The AC component of each channel passes through a band pass filter 86 and then to a sine/cosine separator 90, in the form of two synchronous rectifiers, to derive the sine- and cosine-components of the signal. The two rectifiers for each channel use signal-reversing analog switches driven by two square waves at the frequency of the alternating magnetic field and separated by a quarter of a cycle (90 degrees). The outputs of the rectifiers each contain a D-C component of voltage, either positive or negative depending on the relative phase of the fundamental component of the signal to that rectifier and the phase of the signal driving the magnetic excitation current. The sine and cosine components of the signal are then coupled to sine and cosine low pass filters 92, 94, each of which then provides a signal to an input of the scanning multiplexer 90.

The scanning multiplexer 88 can be arranged to accept the signal components from one, some or all of the elements 70 in a row, with the preferred multiplexer 88 accepting the signal components from all of the elements 70. The multiplexer 88 can then scan through the signal components from the different elements, with the output of the scanning multiplexer 70 containing, for each element, D-C voltages representing the D-C resistance value of each element and the sine- and cosine-related component of resistance of each element. The computer 62 can determine the exact test current by subtracting the actual element voltage from the source reference voltage to determine the exact element resistance. The computer 62 uses these values to determine the present value of the resistance and therefore the changes in width to length ratio of the remaining part of the element as the lapping procedure continues.

The computer 62 can determine the effective magnitude of the magneto-resistive effect of the applied alternating magnetic field by computing the square root of the sum of the squares of the sine and cosine values for each slider. The computer 62 can also determine the phase angle of that field by computing the arc-tangent of the sine value divided by the cosine value. This allows the shifts in phase angle associated with some questionable elements (even those that will change in phase as the lapping continues and become acceptable as the stop point is reached) to be continuously monitored and recorded. The computer 62 can then use this data to control the lapping of the individual sliders.

By including this M-R related data in the lapping algorithm, the yield of acceptable sliders can be improved and lapping procedures can be altered by process development capabilities guided by this information that was not previously available.

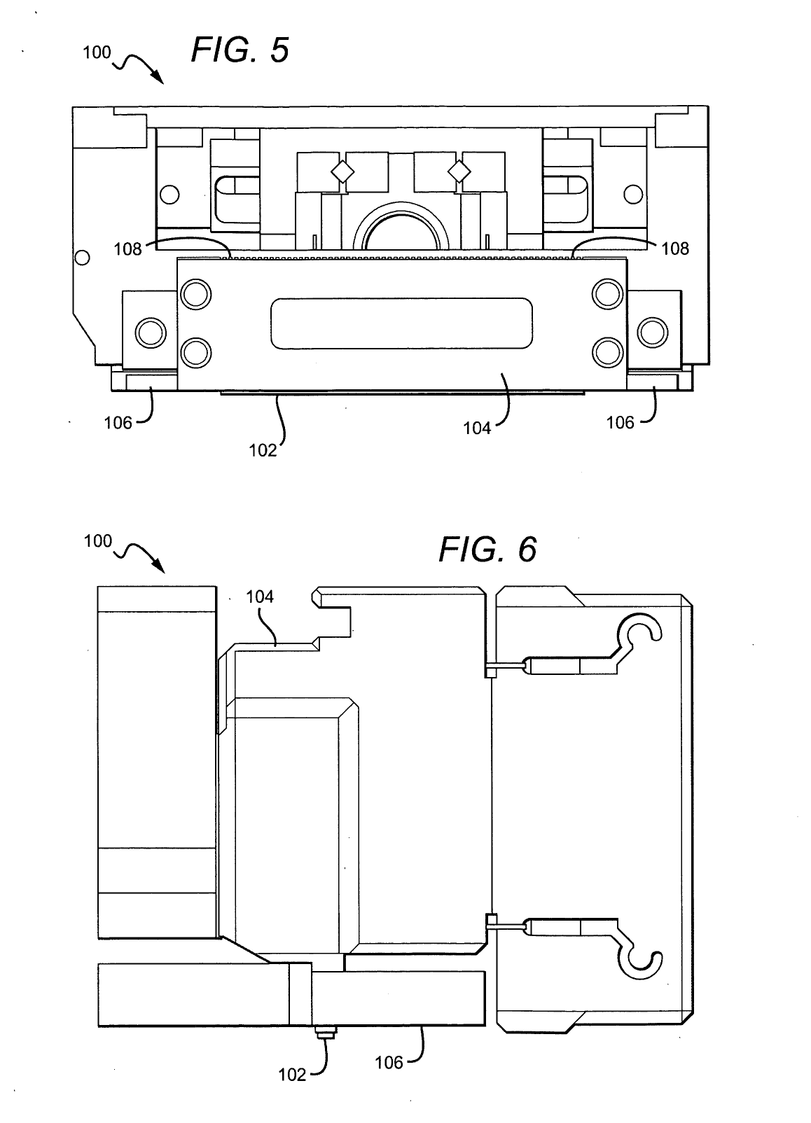

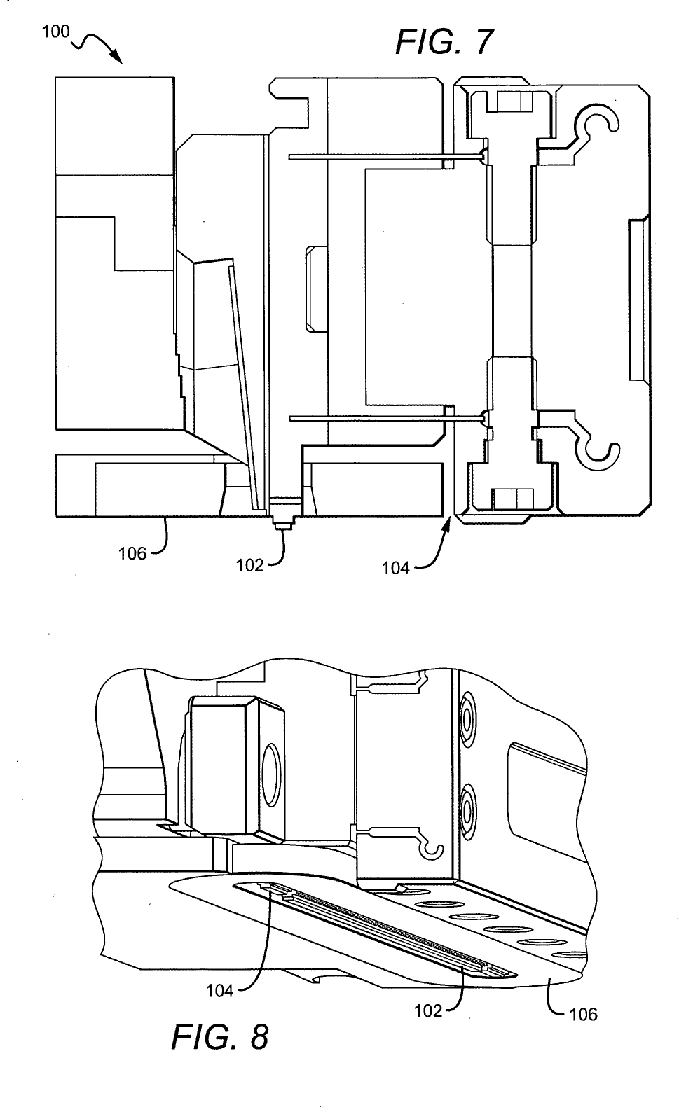

FIGS. 5-8 show one embodiment of a lapping system 100 according to the present invention, although other lapping systems according to the invention can be arranged in other ways with other components. The row of elements 102 is shown as the lowest point in the system and is generally the only contact to the lap plate (not shown), which performs the actual lapping. The row 102 is bonded to a row tool 104 (or the individual actuators of the row tool) and is pressed down on the lap plate while the lap plate is turning in such a way as to provide a “lapping” or “polishing” effect on the surface of the row 102. A coil 106 is arranged around the row and row tool 102, 104 to apply a magnetic field.

During the initial lapping, the bulk resistance of the elements in the row 102 can be measured based on the response to the DC current, as discussed above, without the magnetic field. As the row approaches the final lapping stop point, the magnetic field can be applied to the row 102 from the coil 106 for the final feedback for closed-loop control. In other embodiments, the system 100 can use both the response to DC current and magnetic field through the entire lapping process.

In this embodiment, the magnetic field from the coil 106 is “focused” by means of the row tool 104. The focusing of the magnetic field permits a smaller coil 106 to be used to generate the desired magnetic field excitation. The row tool 104, in this case, has individual control fingers 108 for each element in the row 104. The fingers 108 are made of steel or ceramic with the desired characteristics for row bending, bonding, magnetic properties, long life, thermal properties, etc. for the application. The fingers 108 are designed to transmit the desired force, control other lapping parameters and to focus the magnetic field through the elements being lapped. The coil 106 for the magnetic field excitation must generate a sufficient magnetic field to generate the proper magneto-resistive response while being small enough to fit within the constraints of the lapping system 10.

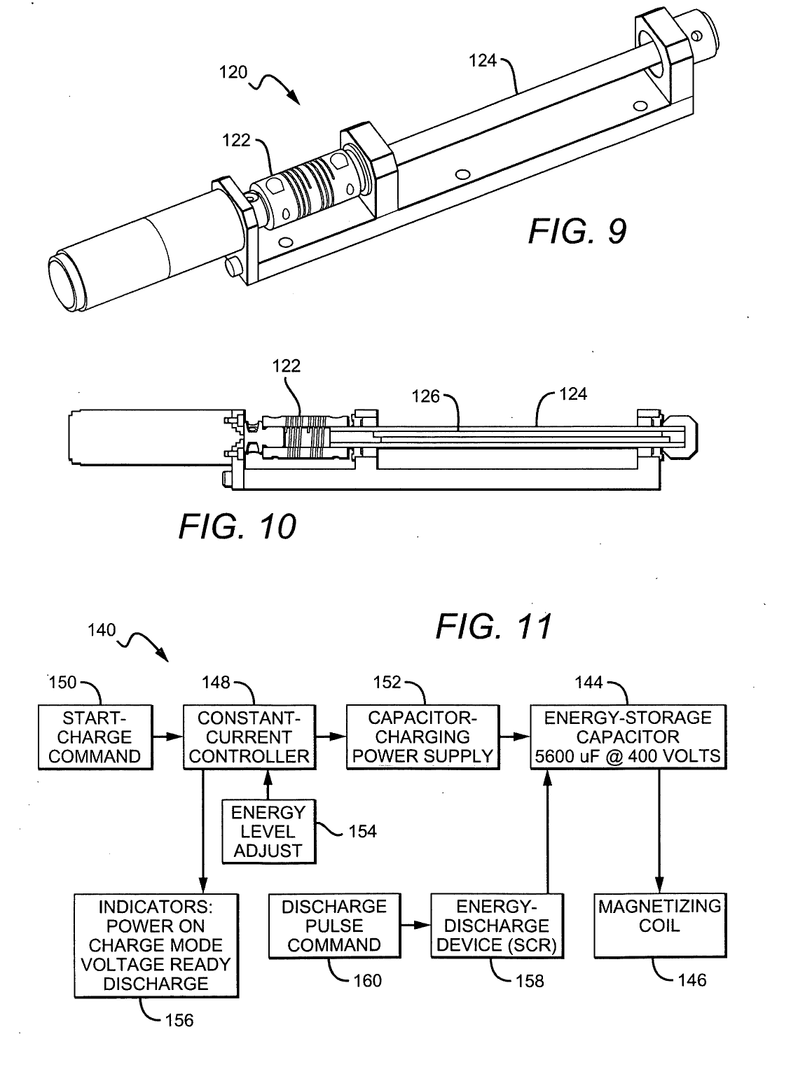

FIGS. 9 and 10 show one embodiment of a rotating magnet apparatus 120 that can be used to generate a magnetic field instead of a coil. A motor 122 is coupled to a bearing-mounted aluminum rod 124 with magnets 126 inside the rod 124. The magnets 126 are longer than the row of elements to achieve a uniform magnetic field strength along the row and the magnetic field strength can be made to have low distortion (deviation from a sine wave magnetic force as measured with a probe calibrated in Gauss). In one embodiment according to the present invention, there are actually two magnets assembled with opposite poles mating so that the outside surfaces would be opposite polarity. The magnets as shown are commercially available.

In an operational system the magnets 126 can be a single unit of a square cross-section manufactured for the application. The magnetic field strength can be adjusted by using different strength magnets 126, by adjusting the spacing of the magnets 126 from the metal of the row tool or by attenuating the field by adjusting a magnetic shield in the magnetic path. Adjusting the speed of the driving motor will change the frequency of the magnetic field without changing its amplitude. One embodiment of a rotating magnet apparatus 120 according to the present invention has a motor speed of 1500 RPM for the drive motor 122 that results in 25 Hertz for the magnetic field frequency.

As described above in the systems in FIGS. 3 and 4, magnetic feedback requires the application of an alternating magnet field to sense the apparent magneto-resistance effect of the element. One of the steps in the systems can comprise multiplying the applied alternating magnetic field with the existing magnetic field. The existing magnetic field may be due to residual magnetism in the element or may be due to the retained part of a magnetic field pulse applied to the row. The residual magnetism can be unpredictable in both magnitude and polarity, which can reduce accuracy when measuring the magneto-resistance effect of the element in an AC magnetic field.

One way to reduce the impact of the residual magnetism is to expose the row to a strong magnetic field pulse before the lapping process begins. This pulse should have a magnitude and polarity such that the magnetic field in the elements is fully saturated, or pinned. The existing magnetic field in the elements will then be predictable such that when the apparent magneto-resistance response to the element in an alternating magnet field can be more accurately measured.

FIG. 11 shows a block diagram of one embodiment of a magnetic pulser system 140 according to the present invention for generating a magnetic pulse to pin the magnetic field of the elements. The system 140 generally comprises electronic elements on a circuit board, an external energy storage capacitor 144, and a magnetizing coil 146, with the magnetizing coil 146 arranged to be placed in close proximity to the row of elements mounted on a row tool. The electronic components for the circuit board are shown in functional blocks in FIG. 11. The row tool can be separated from or mounted in a lapping machine. The system 140 can comprise conventional commercially available components arranged as to function as described herein.

The magnetic pulser system operates under the control of an external computer and in one embodiment the external computer is a conventional personal computer, although other computers can be used. The heart of the magnetic pulser system is a constant current controller 148 that accepts a start charge command 150 from the computer and controls charging of the capacitor 144 through the capacitor-charging power supply 152. Many different capacitors can be used, with a suitable one being a 5600 μF capacitor at 400 volts. The constant current controller 148 also receives energy level adjust commands 154 or control signals from the computer, which dictate the level of capacitor charging. The system 140 also comprises a number of indicators 156 to reflect the condition of the system, such as Power On, Charge Mode, Voltage Ready and Discharge.

The system 140 also comprises an energy discharge device (SCR) 158 that also accepts a discharge pulse command 160 from the computer. After the storage capacitor 144 is charged by the capacitor charging power supply 152 under control of the constant current controller 148, the energy stored in the capacitor 144 can be discharged by the energy discharge device 158. The energy in the capacitor 144 is discharged as a pulse that is transmitted to the magnetizing coil 146, which in turn causes the magnetizing coil 146 to generate a magnetic field pulse that pins the polarity and magnitude of the residual magnetic field in the row elements. The preferred magnetic field generated by the magnetizing coil 146 is 24 kilo gauss, although other magnetic fields can also be used to pin the magnetic field in the row elements. The elements are now in a condition for accurate AC and DC monitoring during the lapping process.

Although the present invention has been described in considerable detail with reference to certain preferred configurations thereof, other versions are possible. Therefore, the spirit and scope of the invention should not be limited to the preferred versions of the invention described above.

1. A method for monitoring the lapping of disk drive elements, comprising:
applying a DC current to a disk drive element having magneto-resistive properties;
applying an alternating magnetic field to said disk drive element;
lapping said disk drive element;
measuring the voltage across said disk drive element in response to said DC current and alternating magnetic field; and
determining the magnetic responsiveness of said element based on said measured voltage.

2. The method of claim 1, further comprising stopping said lapping of said disk drive element when said element exhibits the desired responsiveness to said alternating magnetic field.

3. The method of claim 1, wherein said DC current is generated by a current source that can be manipulated to generate different current levels.

4. The method of claim 1, wherein said alternating magnetic field is provided by a coil in proximity to said disk drive element.

5. The method of claim 4, further comprising an alternating current generator to supply a current to said coil to generate said alternating magnetic field.

6. The method of claim 1, wherein said measured voltage has an AC component, the determination of said magnetic responsiveness comprises computing the square root of the sum of the squares of the sine and cosine values for said AC component.

7. The method of claim 1, wherein said measured voltage has an AC component, wherein the determination of said magnetic responsiveness comprises determining the phase angle of said alternating magnetic field by computing the arc-tangent of the sine value divided by the cosine value for said AC component.

8. A lapping system with closed loop feedback, comprising:
a row tool for holding a row of a plurality of disk drive elements;
a lapping plate for lapping said plurality of disk drive elements;
a current source for applying a direct current to at least one of said disk drive elements;
a coil for applying an alternating magnetic field to said at least one of said disk drive elements;
a monitor to monitor the voltage across said at least one of said disk drive elements in response to said direct current and said alternating magnetic field; and
a processor for determining the magnetic responsiveness of said at least one of said disk drive elements based on said monitored voltage.

9. The system of claim 8, wherein said at least one said disk drive elements comprising a plurality of disk drive elements and wherein said current source comprises a plurality of current sources each of which supplies a current to a respective one of said plurality of disk drive elements.

10. The system of claim 8, wherein said row tool comprises a plurality of fingers, each of which applies a lapping force to a respective one of said plurality of disk drive elements.

11. The system of claim 10, wherein said processor determines the magnetic responsiveness of a plurality of plurality of disk drive elements, said processor further controlling the lapping force applied by said plurality of fingers based on the said determination of said responsiveness.

12. The system of claim 8, wherein said voltage across said at least one said disk drive elements comprises a AC component and a DC component, said monitor separating said AC and DC components.

13. A disk drive element lapping system with closed loop feedback, comprising:
a row of a plurality of disk drive elements;
a lapping plate for lapping said plurality of disk drive elements;
a plurality of current sources, each of which applies a current to a respective one of said plurality of disk drive elements;
a coil for applying an alternating magnetic field to said plurality of disk drive elements;
a plurality of monitors, each of which monitors the voltage across a respective one of said plurality of disk drive elements in response to said direct current and said alternating magnetic field; and
a processor for determining the magnetic responsiveness of each of said plurality of disk drive elements based on said monitored voltage.

14. The system of claim 13, wherein said row is mounted on a row tool.

15. The system of claim 14, wherein said row tool comprises a plurality of fingers, each of which applies a lapping force to a respective one of said plurality of disk drive elements.

16. The system of claim 13, wherein said processor further controls the lapping force applied by said plurality of fingers based on the said magnetic responsiveness of each of said plurality of-disk drive elements.

17. The system of claim 13, wherein said processor comprises a computer.

18. The system of claim 13, wherein said voltage monitored by each of said plurality of monitors comprises an AC component and a DC component, said monitor separating said AC and DC components.

19. The system of claim 18, wherein said AC and DC components of each of said monitors is coupled to inputs of a scanning multiplexer, the output of said multiplexer capable of carrying the AC and DC components of each of said monitors under control of said processor.

20. The method of claim 18, wherein said magnitude responsiveness determination by said processor comprises computing the square root of the sum of the squares of the sine and cosine values for said AC component of said measured voltage.

21. The method of claim 18, wherein the magnetic responsiveness determination by said processor comprises determining the phase angle of said alternating magnetic field by computing the arc-tangent of the sine value divided by the cosine value for said AC component of said measured voltage.
